(19) United States
(12) Patent Application Publication
(10) Pub. No.: US 2016/0171909 A1
(43) Pub. Date: Jun. 16, 2016

(54) WIRELESS MULTI-SENSOR DEVICE AND SOFTWARE SYSTEM FOR MEASURING PHYSICAL PARAMETERS

(71) Applicant: MYRIAD SENSORS, INC., MOUNTAIN VIEW, CA (US)

(72) Inventors: CLIFTON ROOZEBOOM, Mountain View, CA (US); Adrian Albert, Burlingame, CA (US); David Bakker, San Jose, CA (US)

(21) Appl. No.: 14/966,826

(22) Filed: Dec. 11, 2015

Related U.S. Application Data
(60) Provisional application No. 62/092,163, filed on Dec. 15, 2014.

(51) Int. Cl. G09B 23/00; A63H 33/26

(52) U.S. Cl. CPC G09B 23/00; A63H 33/26

(57) ABSTRACT

An apparatus for a transportable toy system is provided. A transportable toy system comprising a toy body, a cavity within the toy body, and a sensor package within the cavity of the toy body. The sensor package comprises one or more processors, a plurality of electronic digital sensors coupled to the one or more processors, a wireless networking transceiver coupled to the one or more processors, and non-transitory computer-readable storage medium coupled to the one or more processors and storing one or more sequences of instructions. The sensor package is removable from the cavity of the toy and if removed utility of the toy is maintained. The sensors in the sensor package may be an accelerometer, an altimeter, a gyroscope, and/or other sensors. The instructions stored on the non-transitory computer-readable storage medium cause the one or more processors to detect a set of changes, based on readings from the sensors, to the toy in response to a change in position of the toy. The change in position of the toy may include a change in position along the x-axis, the y-axis, and/or the z-axis; a change in velocity along one or more axes; and/or a change in acceleration along one or more axes. As the changes are detected, the processor(s) generate one or more signals that represent measurements that may include acceleration, velocity, position, height, or rotation of the toy. As the changes are detected, the processor(s) transmit the one or more signals via a wireless networking transceiver to a mobile computing device that is separate from the toy. A host computer that is separate from the toy and from the mobile computing device may comprise a second computer-readable medium storing second downloadable application instructions which cause the mobile computing device to receive the one or more signals transmitted from the sensor package. The downloadable application instructions then cause the mobile computing device to compile one or more data series comprising a plurality of values representing a plurality of measurements from the one or more signals. The data series represent at least one of acceleration, velocity, position, height, or rotation of the toy in one or more directions. The mobile computing device then presents the one or more data series on a multi-axis graph.

### BENEFIT CLAIM

This application claims the benefit under 35 U.S.C. §119(e) of provisional application 62/092,163, filed Dec. 15, 2014, the entire contents of which is hereby incorporated by reference for all purposes as if fully set forth herein.

### FIELD OF THE DISCLOSURE

The present disclosure relates to the field of education. More specifically, the disclosure comprises a sensor and software system used to aid the teaching of science concepts.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

There are many known techniques and devices for teaching science concepts. Most of these include simple devices constructed to illustrate various principles, for example, a ramp to demonstrate force and friction, a pendulum to display harmonic motion, circular objects or simple balls to show elastic and inelastic collisions, or gravity acting on a falling object. More advanced classrooms will use electronic devices that can measure temperature, force, pH, or other parameters. Most of these include wired probes and base station modules with electronics and displays.

In recent years, inexpensive sensors have been developed primarily for the mobile computing or smart phone market that can measure temperature, acceleration, humidity, barometric pressure, and other parameters, and these are integrated with functions of the smart phone for games, tracking motion, and other purposes. Many companies are making sensors available separately so that they can be integrated into other devices and inventions. However, many sensor devices that capture measurements and transmit these measurements can be bulky or heavy enough to influence the trajectory of the object itself. For example, if a sensor is attached to a football, then the size, weight, and placement of the projectile is likely to influence the trajectory and the rotation of the ball when thrown such that the flight path of the football with the attached sensor is not representative of the expected flight path of the football itself.

Other sensors may have designs that make them small enough and light enough so as not to influence the object that they are attached to. However, many of these smaller and lighter sensors are made more compact by removing such functionality as the number of sensors or the wireless transmission unit. By removing functional parts of a multi-sensor device the user is left with a sensor unable to transmit measurements to an external computer as they are being measured.

Other solutions may include designing an object, such as a ball, with the components of the sensor tightly integrated and distributed within the portions of the object. By doing so, the flight trajectory and rotation may not be unnecessarily skewed by the sensor. However, this type of sensor is then only usable with the object that it is tightly integrated in and does not give the user the freedom to removing the sensor from one object and inserting the sensor into another object.

### BRIEF DESCRIPTION OF THE DRAWINGS

In the drawings:

FIG. 1 illustrates an embodiment of a transportable toy system including interactions between a mobile computing device, a sensor package, and a host computer.

FIG. 2 illustrates an example diagram of a sensor card mounted in a protective case

FIG. 3 illustrates inner components of the multi-sensor device and their functional connections.

FIG. 4 illustrates a system diagram of wireless communication from a multi-sensor device to a mobile computing device and communication from the mobile computer device to a server-side backend computer system.

FIG. 5 illustrates an example technology stack and the data flow between multiple layers that make up the transportable toy system.

FIG. 6 illustrates an example flow diagram of detected sensor data from the multi-sensor device to the mobile computing device.

FIG. 7 illustrates example firmware implemented on the multi-sensor device designed to regulate different modes on the microcontroller and the multiple sensors.

FIG. 8 illustrates multiple views on a user interface of the mobile computing device.

FIG. 9A and FIG. 9B illustrate an example web interface where a user may track and annotate current and previous experiments.

FIG. 10 illustrates an embodiment of a toy as a pendulum.

FIG. 11 illustrates an embodiment of the toy as a soccer ball.

FIG. 12 illustrates an example ramp with the multi-sensor device resting on the ramp.

FIG. 13 illustrates a bicycle with the multi-sensor device attached to the inside of the bicycle wheel.

FIG. 14 illustrates multiple embodiments of a mechanical mount that holds the multi-sensor device.

FIG. 15 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present disclosure. It will be apparent, however, that the present disclosure may be practiced without these specific details. In other instances, well-known structures and devices are shown in block diagram form in order to avoid unnecessarily obscuring the present disclosure. For purposes of clarity and conciseness, in some instances this disclosure refers to certain data values, which are stored and used in electronic digital form in memory or non-volatile storage, using labels that represent concepts or abstractions. However, each instance in this detailed description of using or referring to an abstract item or concept is intended to encompass one or more electronically digitally stored instructions or data values that represent or correspond to the specified abstract item or concept. In other words, the disclosure is directed to practical applications of the concepts described herein using the particular computers, computer memory, computer storage, and computer communications that are described herein, and is not intended to encompass all means of implementing the abstract items or concepts nor to encompass the abstract items or concepts themselves. Embodiments are disclosed in sections according to the following outline:
1. GENERAL OVERVIEW
2. SYSTEM OVERVIEW
2.1. TOY OBJECT
2.2. SENSOR PACKAGE
2.3. MOBILE DEVICE
2.4. SERVER-SIDE BACKEND COMPUTER
2.5. TECHNOLOGY STACK
3. FUNCTIONAL OVERVIEW
4. USER INTERFACE
5. EMBODIMENTS OF TOY OBJECTS
6. EXTENSIONS AND ALTERNATIVES
7. HARDWARE OVERVIEW

1. General Overview

In an embodiment, a transportable toy system comprises a toy body, a cavity within the toy body, and a sensor package within the cavity of the toy body. The sensor package comprises one or more processors, a plurality of electronic digital sensors coupled to the one or more processors, a wireless networking transceiver coupled to the one or more processors, and non-transitory computer-readable storage medium coupled to the one or more processors and storing one or more sequences of instructions. The sensor package is removable from the cavity of the toy and if removed the utility of the toy is maintained.

The plurality of electronic digital sensors within the sensor package may include a combination of an accelerometer, an altimeter, a gyroscope, and/or other sensors. The instructions stored on the non-transitory computer-readable storage medium may be programmed to cause one or more processors to detect a set of changes, based on readings from the attached sensors, to the toy in response to a change in position of the toy. The change in position of the toy may include: a change in position along the x-axis, the y-axis, and/or the z-axis; a change in velocity along one or more axes; and/or a change in acceleration along one or more axes. As the changes are detected, the one or more processors generate one or more signals that represent measurements that may include acceleration, velocity, height, or rotation of the toy. As the changes are detected, the one or more processors transmit the one or more signals via a wireless networking transceiver to a mobile computing device that is separate from the toy.

A host computer that is separate from the toy and from the mobile computing device comprises a second non-transitory computer-readable medium storing second downloadable application instructions which when downloaded to and executed by the mobile computing device cause the mobile computing device to receive the one or more signals transmitted from the sensor package. The downloadable application instructions then cause the mobile computing device to compile one or more data series comprising a plurality of values representing a plurality of measurements from the one or more signals. The one or more data series represent at least one of acceleration, velocity, height, or rotation of the toy in one or more directions. The mobile computing device then presents the one or more data series on a multi-axis graph to the user.

2. System Overview

2.1. Toy Object

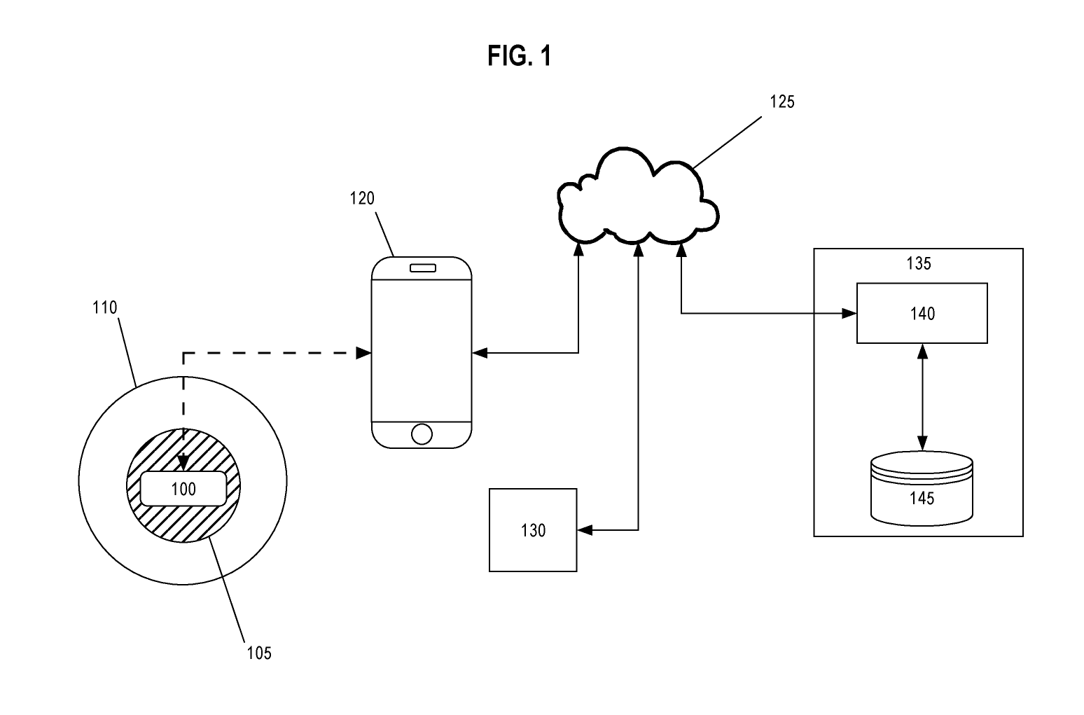

FIG. 1 illustrates an embodiment of a transportable toy system including certain interactions between a mobile computing device, a sensor package, and a host computer.

In an embodiment, a toy, such as a ball in the example of FIG. 1, has a toy body 110, which may correspond to an outer shell of the toy. For example, if the toy is a soccer ball or football, then the outer casing of the soccer ball is the toy body 110. In the case of foam balls, the toy body 110 may include foam elements under the outer casing. The toy comprising the toy body 110 and the toy cavity 105 may comprise various types of objects including, but not limited to, a soccer ball, a basketball, a football, a toy car, a pendulum weight, and others. Typically the toy facilitates use of sensors to measure physical and atmospheric changes to the toy.

An inner toy cavity 105 is formed in toy body 110. The toy cavity 105 has a size sufficient to house a removable multi-sensor device 100, which is wirelessly coupled to a mobile computing device 120. In various embodiments the mobile computing device 120 may comprise a smartphone, a tablet computer, and a laptop computer. The mobile computing device 120 is connected to a network 125, through which the mobile computing device is able to communicate with server-side backend computer system 135 and a web interface 130. The server-side backend computer system 135 may implement cloud networking for the purpose of sharing data between users of multiple multi-sensor devices. The web interface 130 is a graphical user interface that allows the user to interact with the captured multi-sensor data. The web interface 130 may comprise a web browser such as Internet Explorer, Google Chrome, or Mozilla Firefox, running on a computer.

In an embodiment, the toy cavity 105 is positioned within the toy body 110 such that when the multi-sensor device 100 is placed within the toy cavity, the weight distribution of the toy body across x, y, and z-axes remains unchanged. For example, if the toy is a ball, such as a soccer ball, the toy cavity 105 may be positioned at the center point of the x, y, z-axes so that the toy cavity does not disrupt the weight distribution of the ball.

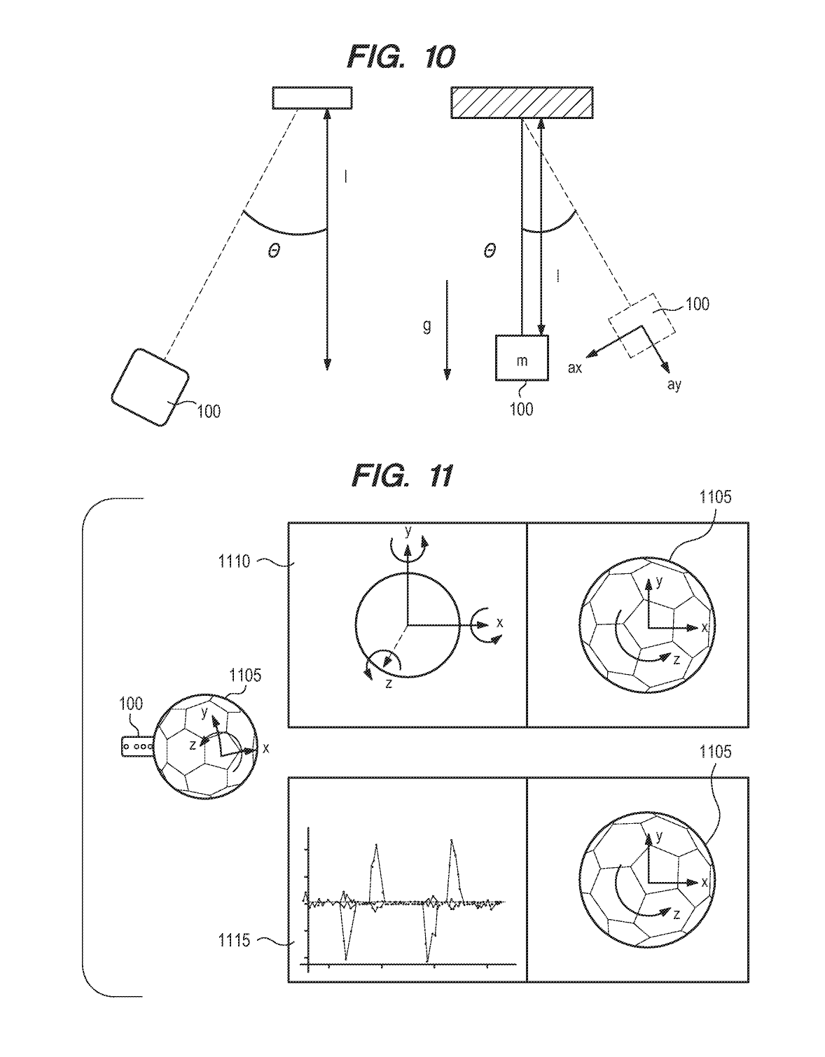

FIG. 11 depicts an embodiment of a toy in the form of a soccer ball. The multi-sensor device 100 is inserted into the toy cavity 105 of the soccer ball 1105 so that the multi-sensor device 100 is positioned at the center of the soccer ball 1105. By doing so, the multi-sensor device may be able to measure rotational speed along any of the x, y, and z-axes, as depicted in box 1110. Graph 1115 depicts the measurement of rotation along the z-axis for the soccer ball 1105. The positive spikes on graph 1115 depict rotation in one direction around the z-axis, while the negative spikes on graph 1115 depict rotation in the other direction around the z-axis.

Other embodiments of the toy may include the toy as a car or a pendulum weight, where weight distribution is not centered on the center point of the x, y, and z-axes. In this case, the toy cavity 105 may be positioned so that it is located at the center point based on weight distribution of the toy. Other embodiments of the toy, the toy body 110, and the toy cavity 105 are discussed in detail in the EMBODIMENTS OF TOY OBJECTS section herein.

2.2. Sensor Package

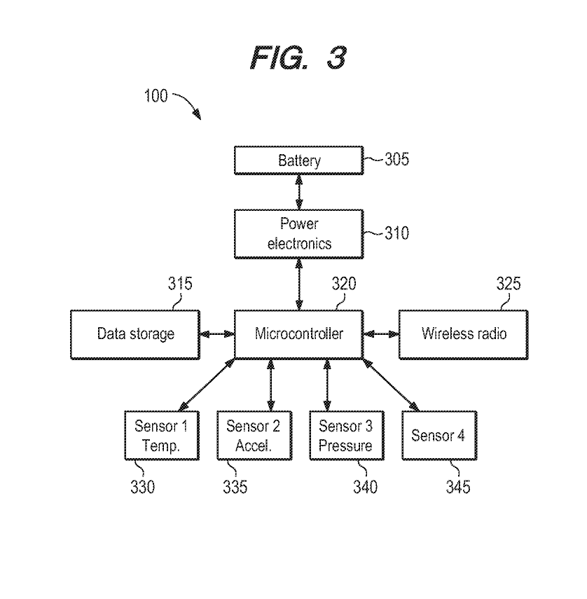

In an embodiment, multi-sensor device 100 is a sensor package comprising a battery unit, power electronics, a microcontroller, a data storage unit, a wireless radio device, and multiple sensor units. FIG. 3 depicts example inner components of the multi-sensor device 100 and their functional connections. In an embodiment, a battery 305 provides power unit for the multi-sensor device 100, and may be coupled to power electronics 310, which may be configured to regulate voltage from the battery 305 to maintain power requirements for the multi-sensor device 100. Power electronics 310 and battery 305 may form a regulated DC power supply and may implement power conservation logic. For example, if the multi-sensor device 100 has not detected any change in the environment or position of the toy, the multi-sensor device 100 may switch to a sleep or power saving mode in order to conserve the limited power stored in the battery 305. In this example, the power electronics 310 may regulate the power consumption to the microcontroller 320 or other components by restricting the total power throughput from the battery 305 or by selectively turning off select components, such as sensors or wireless radio 325, within the multi-sensor device 100.

In an embodiment, the microcontroller 320 is configured to perform specific data input and output tasks between the other components within the multi-sensor device 100. For example, the microcontroller 320 is configured to receive sensor data from the multiple sensors and send the sensor data to the data storage unit 315 for temporary or permanent storage. The microcontroller 320 is also configured to the send the stored sensor data to the wireless radio unit 325 where the sent sensor data is then wirelessly transmitted to the mobile computing device 120.

In an embodiment, the data storage unit 315 within the multi-sensor device 100 may include, but is not limited to, a magnetic disk, optical disk, solid-state drive, or other dynamic storage media. In an embodiment the wireless radio 325 is configured to transmit sensor data via a wireless network using communications such as, Bluetooth, Bluetooth low energy, WiFi, ZigBee, or any other wireless protocol.

In an embodiment, the microcontroller 320 is coupled to one or more sensor devices. FIG. 3 depicts an example multi-sensor device 100 containing four sensor units. Other embodiments may contain any number of sensors. In an embodiment, sensor 330 is a temperature sensor configured to measure the outside temperature. In an embodiment, sensor 335 is a three-axis accelerometer configured to measure acceleration over the x, y, and z-axes. In an embodiment, sensor 340 is a pressure sensor configured to measure atmospheric pressure. In an embodiment, sensor 345 may comprise any of several different sensors including, but not limited to, a three axis gyroscope, a three axis magnetometer, a humidity sensor, a barometric pressure sensor, an infrared temperature sensor, or any other sensor.

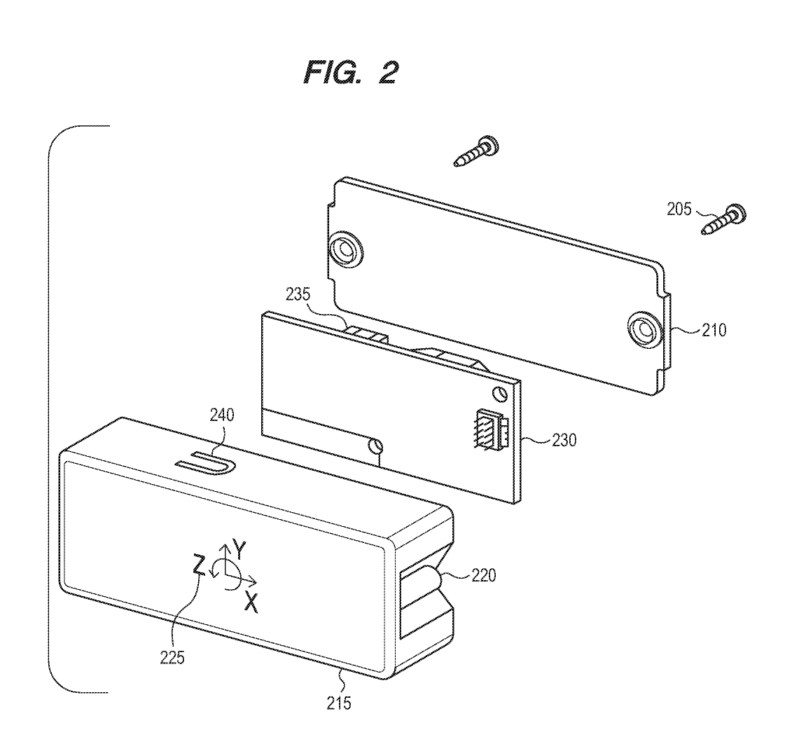

FIG. 2 depicts an example diagram of a sensor card mounted in a protective case and example features of the case such as a lens for visible, UV, infrared light, or other light, various mechanical switch apparatus. In an embodiment, the sensor card 230 is a digital electronic circuit board that may comprise the electronic components described herein with respect to FIG. 3.

FIG. 2 shows an example in which the sensor card 230 is mounted in a protective case that can protect the sensor card 230 from impact, water, and other environmental issues, and also serve as a secure mounting point. In an embodiment, the case of FIG. 2 comprises a case back 210 that is affixed to the sensor card using two or more assembly screws 205, or other fasteners.

The card 230 may include an electronic switch 235 that may rest against a mechanical button 240 configured in a side wall of the case front 215, which is configured to fit snugly over the sensor card 230 and mate to the case back 210 using the screws 205. In an embodiment the electronic switch 235 is configured to provide single-button control for turning on the sensor card 230 and causing power-up, initialization, and triggering execution of instructions in firmware. In an embodiment the case front 215 has indicia 225 indicating axes to enable the user to orient sensors in a particular way. The indicia 225 may be printed, engraved, embossed, or molded in the case front.

2.3. Mobile Computing Device

In an embodiment, the mobile computing device 120 is a laptop computer, tablet computer or smartphone that connects to the multi-sensor device 100 using a wireless networking protocol. In an embodiment a host computer, which is separate from the mobile computing device 120, may include downloadable application instructions for the mobile computing device 120. The mobile computing device 120 may be configured to download the downloadable application instructions using a standard web browser or a stand-alone app store program such as the APPLE APP STORE. In an embodiment, the downloadable application instructions may include a downloadable dashboard application that is used to communicate with the multi-sensor device 100 and the server-side backend computer system 135 and to display the received sensor signals on a multi-axis graph for the user.

In an embodiment, the mobile computing device 120 uses communication protocols including, but not limited to, Bluetooth, Bluetooth low energy, WiFi, or Zigbee, to communicate with the multi-sensor device 100. The mobile computing device 120 may also use multiple communication protocols to communicate the received sensor data to the server-side backend computer system 135.

2.4. Server-Side Backend Computer

In an embodiment, the server-side backend computer system 135 may be implemented using one or more server computers or a distributed cloud infrastructure. The server-side backend computer system 135 may comprise server software including Representational State Transfer (REST) APIs that are used to send and receive data and data requests from multiple mobile computing devices connected via the network 125. In an embodiment, data received from multiple mobile computing devices may be persistently stored within a storage database 145. Embodiments of the storage database 145 include, but are not limited to, relational databases, object databases, or any other data management system.

In an embodiment, the storage database 145 may be used to organize the data received from the multiple mobile computing devices based upon each multi-sensor device, geo-location associated with the data, or any other annotated notes related to the data such as an experiment name, user, or user group.

2.5. Technology Stack

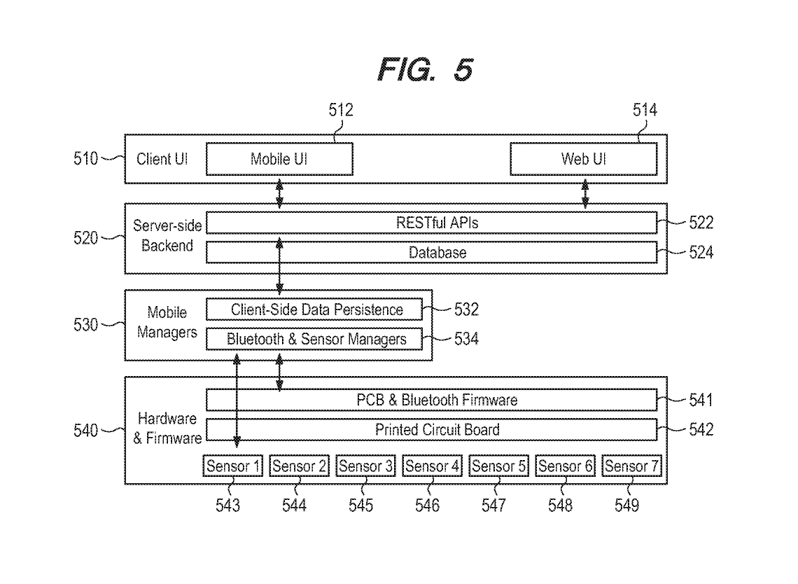

FIG. 5 illustrates an example technology stack and the data flow between multiple layers that make up the transportable toy system. In an embodiment, a four-layer architecture is implemented.

Elements of FIG. 5 may be implemented using one or more computer programs or other programmed software elements such as function libraries. A first layer 510 comprises a client user interface (client UI) that may implement a mobile device user interface 512 based upon any of a plurality of mobile device operating systems or architectures including, but not limited to, Apple iOS, Google Android, and Windows Mobile. The client UI may implement a web user interface 514 that provides support for major browsers including, but not limited to, Internet Explorer, Google Chrome, and Mozilla Firefox.

The first layer 510 may be coupled via API calls or other interfacing to a second layer 520, which may include the server-side backend computer system 135, which implements server-side back-end functions via RESTful APIs 522 and a database layer 524. The second layer 520 may be coupled to a third layer 530 comprising mobile managers 530, such as a client-side data persistence module 532 and one or more Bluetooth and/or sensor manager modules 534. The client-side data persistence module 532 and manager modules 534 may be used to program parameters on the multi-sensor device 100. The third layer 530 may be coupled using primitive calls or digital logic at the hardware level to a fourth layer 540 that implements hardware and firmware within the multi-sensor device 100, such as PCB and Bluetooth firmware 541 and also includes a printed circuit board 542 of the sensor card and attached sensors, represented as sensors 543, 544, 545, 546, 547, 548, and 549.

3. Functional Overview

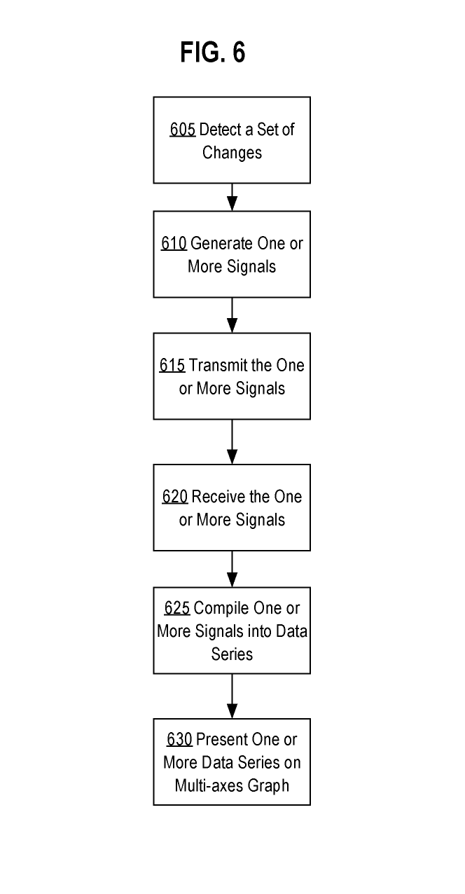

FIG. 6 illustrates an example process of detecting sensor data using the multi-sensor device in the toy and communicating data to the mobile computing device, which then displays the detected sensor data as part of a data series that is graphed for the user.

At step 605 the multi-sensor device 100 detects a set of changes to the toy. In an embodiment, the changes include, but are not limited to, changes in position of the toy and changes to the ambient environment surrounding the toy such as a change in pressure or a change in temperature. The multi-sensor device 100 is equipped with multiple sensors that are able to detect the set of changes to the toy. For example, the toy could be thrown, rolled, or otherwise moved and in response, the sensors would detect positional changes of the toy and generate corresponding position or motion data.

In an embodiment, the multi-sensor device 100 includes a three-axis accelerometer, which is configured to detect acceleration along the x, y, and z-axes. The accelerometer may be configured to measure acceleration as g-forces.

In an embodiment, the multi-sensor device 100 includes a gyroscope sensor, which is configured to measure the extent and rate of rotation in space (roll, pitch, yaw) of the toy.

In an embodiment, the multi-sensor device 100 includes a magnetometer, which is configured to detect angular measurements relative to the Earth's magnetic field.

In an embodiment, the multi-sensor device 100 includes a hygrometer for measuring humidity. Other embodiments may implements different sensors to measure humidity surrounding the toy. For example, the multi-sensor device 100 may include a barometer to measure barometric pressure and humidity of the air.

In an embodiment, the multi-sensor device 100 includes a pressure sensor that may be used to detect changes in atmospheric pressure around the toy. For example, the multi-sensor device 100 may be inserted inside of a sealed plastic bag that contains a volume of air. In this configuration, applied force for a weight outside the bag may create a pressure change within the bag that is detected by the pressure sensor on the multi-sensor device 100.

In an embodiment, the multi-sensor device 100 includes a temperature sensor, which detects the current ambient temperature surrounding the ball. In another embodiment, the multi-sensor device 100 may include an infrared temperature sensor, where the toy cavity 110 and the toy body 105 may be configured with a visible access point so that the infrared temperature sensor can detect the temperature using incident radiation.

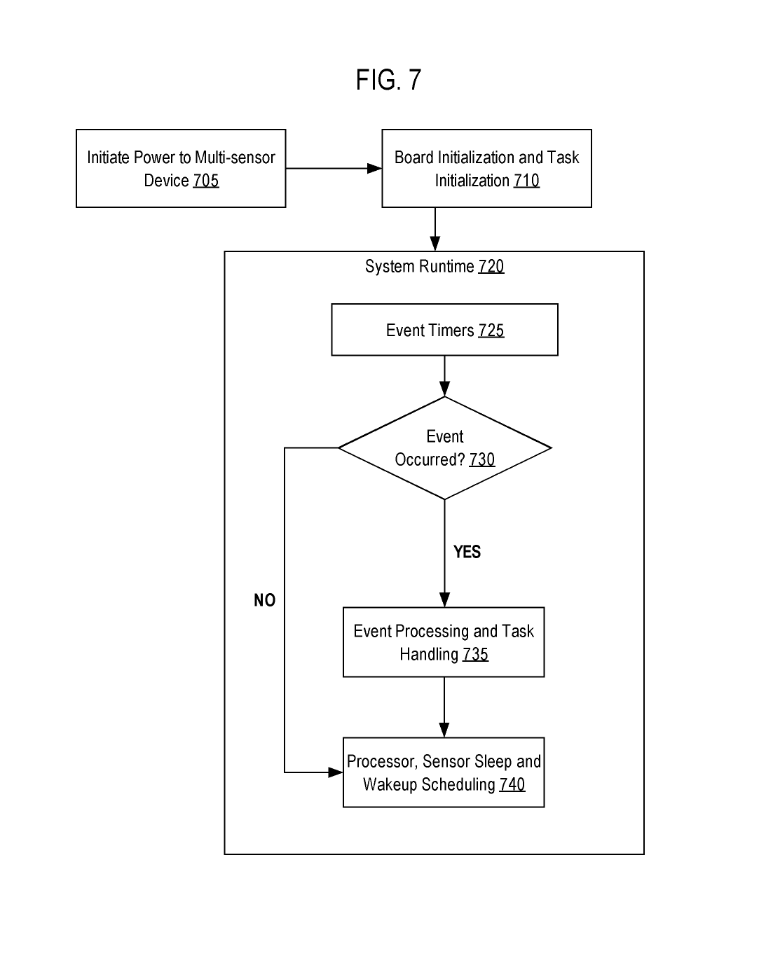

In an embodiment, the multi-sensor device 100 may be configured with timers that regulate when the multiple sensors are actively detecting changes. FIG. 7 depicts example firmware implemented on the multi-sensor device 100 designed to regulate different modes on the microcontroller 320 and the multiple sensors 330-345. Different modes may include a “sleep” and an “awake” mode. The sleep mode means that the microcontroller 320 is not actively receiving data from the sensors or sending data to the data storage 315 and wireless radio 325. The sensors, during sleep mode may be configured to detecting changes in a reduced power mode. In an awake mode, the sensors and the microcontroller 320 actively detect and send or receive data.

As shown at step 705, power is initiated on the multi-sensor device 100 when it is manually turned on. At step 710, the circuit board on the sensor card 230 is initialized which loads or creates a system runtime 720, which may comprise a programmed routine that continually loops through timed intervals to determine whether a detection event or non-event has occurred. Based a detection event or non-event the system runtime 720 sets an appropriate mode for the microcontroller 320 and the multiple sensors.

At step 725, an event timer may activate and test for an event. The event may be a programmed routine operating according to a timed interval within the system runtime 720 that signals that the system runtime needs to test whether an event or non-event has occurred. An event may be characterized as detecting a change in the position of the toy or a change in the surrounding environment. A non-event is characterized as not detecting any changes during the duration of the event timer.

At step 730, the system runtime 720 determines whether an event has occurred. If an event occurred, for example, one or more sensors detected a change to the toy, then the system runtime 720 processes the event. If no event occurred, then the system runtime 720 signals the microcontroller 320 and sensors to enter a sleep mode.

Step 735 depicts receiving an event at which a change to the toy is detected and the system runtime 720 proceeds with processing the event by the microcontroller 320. After processing the received event, the system runtime 720 sets the microcontroller 320 and the multiple sensors to a sleep mode at step 740. Step 740 depicts sensor sleep and wakeup scheduling. In an embodiment, sleep and wakeup scheduling may include setting the microcontroller and the multiple sensors to sleep of a specific period of time. The sleep and wake up scheduling may also be configured to wake the microcontroller and multiple sensors after a specific period of time. Step 740 may be directly initialized from step 730, if no event was previously detected at step 730. The system runtime 720 is configured to evaluate different events in order to determine when to process changes and when to initialize generation of digital signals that represent the detected changes.

At step 610, the multi-sensor device 100 generates signals based upon the detected set of changes. For example, if the accelerometer sensor of the multi-sensor device 100 detects a change in g-force along the z-axis, then the multi-sensor device 100 would generate a signal that represents acceleration along the z-axis. In an embodiment, the generated signal may be a digital signal that represents the amount of g-force along the z-axis at that given time.

In an embodiment, the digital signal may be stored temporarily in data storage 315. The purpose of storing the digital signal within the data storage 315 is to ensure data loss does not occur during transmission failure. In the case of transmission failure to the mobile computing device 120, the multi-sensor device 100 may be configured to resend the stored data until an acknowledgement is received from the mobile computing device 120.

At step 615, the multi-sensor device 100 transmits the one or more signals using a wireless radio 325 to the mobile computing device 120. In an embodiment, the wireless radio 325 receives the one or more signals from the microcontroller 320 and transmits the signals using wireless protocols such as, Bluetooth, Bluetooth low energy, WiFi, ZigBee, or any other commercially available wireless protocol.

At step 620, the mobile computing device 120 receives the transmitted signals by the multi-sensor device 100. In an embodiment, the mobile computing device 120 is configured to receive signals using many different wireless protocols such as Bluetooth, Bluetooth low energy, WiFi, ZigBee, or any other commercially available wireless protocol.

At step 625, the mobile computing device 120 compiles the received signals into a data series. A data series is a time series of multiple data points comprising successive measurements made over a specific time interval. For example, if the mobile computing device 120 receives a stream of signals indicating changes in acceleration for the toy over a period of 60 seconds, then the mobile computing device 120 may compile the signals to create an acceleration data series that is comprised of acceleration measurements at multiple time periods for each axis during the 60 second time period.

At step 630, the mobile computing device 120 presents a data series by overlaying the data series onto a graph displayed on a graphical user interface. In an embodiment, the data series is graphed by using the timestamps associated with the data points in the data series as one axis and the data values as the other axis on the graph.

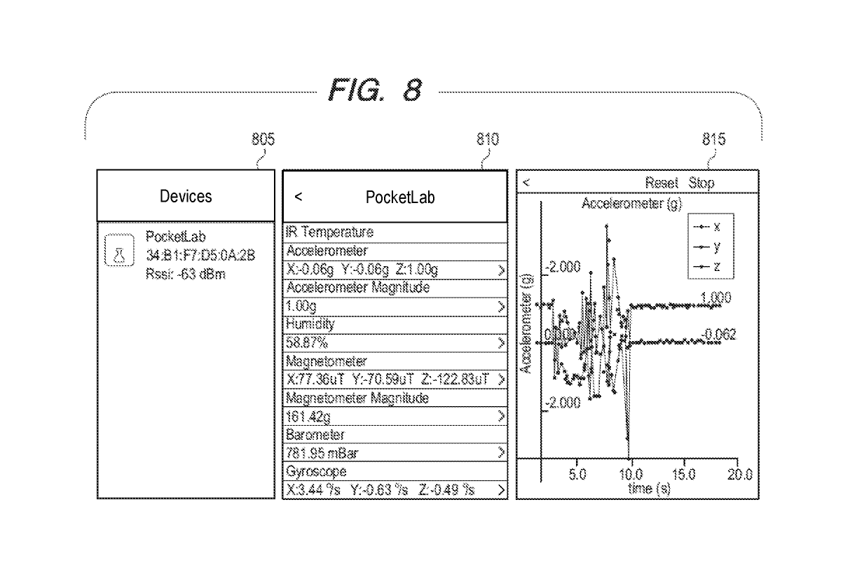

FIG. 8 depicts multiple views of a user interface of the mobile computing device 120. In view 815, the mobile computing device 120 displays a graph of the received data series for acceleration. In view 815, the x-axis defines the time value, in seconds, and the y-axis displays the acceleration, in g-forces, for each of the three measured axes. In an embodiment, each of the measured axes may be identified by using a different color for each axis.

4. User Interface

In one embodiment, the mobile computing device 120 is configured to allow the user to: view multiple data series in graphical representation form, configure parameters of the wirelessly connected multi-sensor device 100, and upload the multiple data series to the server-side backend computer system 135 for user collaboration over a cloud network.

In an embodiment, the user interface on the mobile computing device 120 may allow the user to view diagnostic information related to each of the connected multi-sensor devices. Referring again to FIG. 8, as an example, view 805 depicts a listing of connected multi-sensor devices that are configured to send sensor data to the mobile computing device 120. In view 805, the multi-sensor device 100 is identified using the MAC address of the multi-sensor device 100. In an embodiment, the multi-sensor device 100 may also display connection information related to the quality of the signals received by the connected multi-sensor device 100. For example, in view 805 the Received Signal Strength Indicator (RSSI) value is displayed. The RSSI is a signal strength indicator, measured in decibels, that is based upon the power level of the radio frequency sent from the multi-sensor device 100.

In an embodiment, multi-sensor device 100 may be configured to display different types of data series, where each data series represents data signals from different sensors installed on the multi-sensor device 100. View 810 depicts an example view of available types of data series for viewing in graphical form. In view 810, the user may be able to select a graphical view of a data series related to acceleration, humidity, magnetism, barometric pressure, three-dimensional position based on the gyroscope, and temperature. In an embodiment, the user may configure the starting or stopping of each data series collected. For example the user interface may allow the user to stop the current collection and compiling of the acceleration data series by selecting the data series in view 810, then stopping the data series collection by pushing the “Stop” button shown in view 815. In an embodiment, the user interface allows the user to clear the currently collected data series by pressing the “Reset” button, as displayed in view 815. By doing so, the current acceleration data series is deleted and the user may start a new acceleration data series by pressing the “Start” button (not shown), which is displayed after the “Reset” button is pressed.

In an embodiment, the mobile computing device 120 may be used to upload multiple data series to a server-side backend computer system 135. The server-side backend computer system 135 may be configured to store multiple data series from multiple mobile computing devices for the purpose of viewing the data from other devices and for aggregating multiple data series into a larger aggregated data series that may represent test sessions from different users.

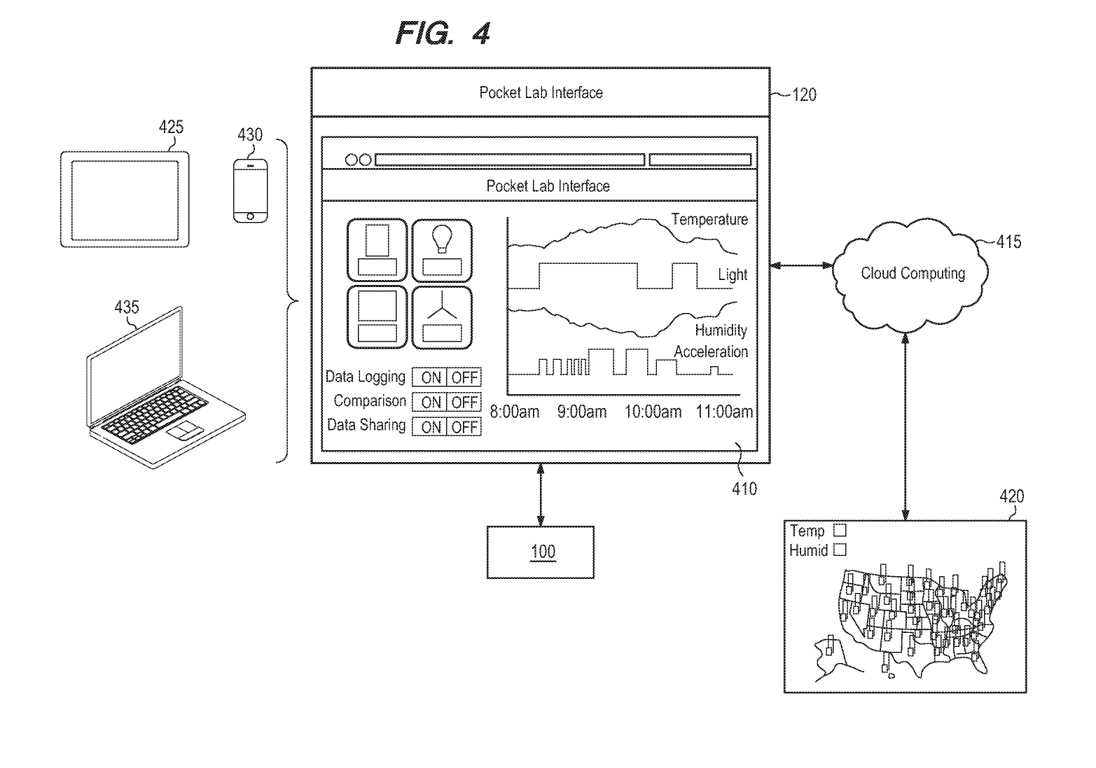

FIG. 4 illustrates a system diagram of wireless communication from the multi-sensor device to a mobile computing device and communication from the mobile computing device to a server-side backend computer system represented as a cloud computing system. The multi-sensor device 100 wirelessly communicates with the mobile computing device 120. The mobile computing device 120 may represent any computing device that is capable of receiving a wireless signal from the multi-sensor device 100. In FIG. 4, the mobile computing device 120 is depicted as either: a tablet 425, a smartphone 430, or a mobile computer such as a laptop 435. Interface 410, within the mobile computing device 120, depicts an embodiment of the mobile interface. The interface 410 may be configured to display different options on different screens based upon the type of device used. For example, if the mobile computing device 120 is a tablet 425 or laptop 435, then the interface 410 may display different options such as, data logging, comparison, or data sharing on the graph display screen. In other embodiments of the interface 410 may hide logging, comparison, and sharing options and may make the options available to the user after clicking an options button.

In an embodiment, data series compiled in mobile computing device 120 may be uploaded to a server-side backend computer system 135. In FIG. 4, the server-side backend computer system 135 is represented as a cloud computing system 415. The cloud computing system 415 may be accessible my multiple users for the purpose of merging data from similar experiments. View 420 illustrates an example graph of merged temperature and humidity data from multiple mobile computing devices that uploaded temperature and humidity experiment data from across multiple regions in the United States. An experiment may be defined as a set of one or more data series that are used to describe a performed test on the toy. For example, if the user tested the occurrence of multiple forces on the toy when thrown at a wall, then the experiment may include data series for the acceleration when throwing and hitting the wall, the trajectory of the throw and the trajectory of the bounce back, and the pressure observed during impact.

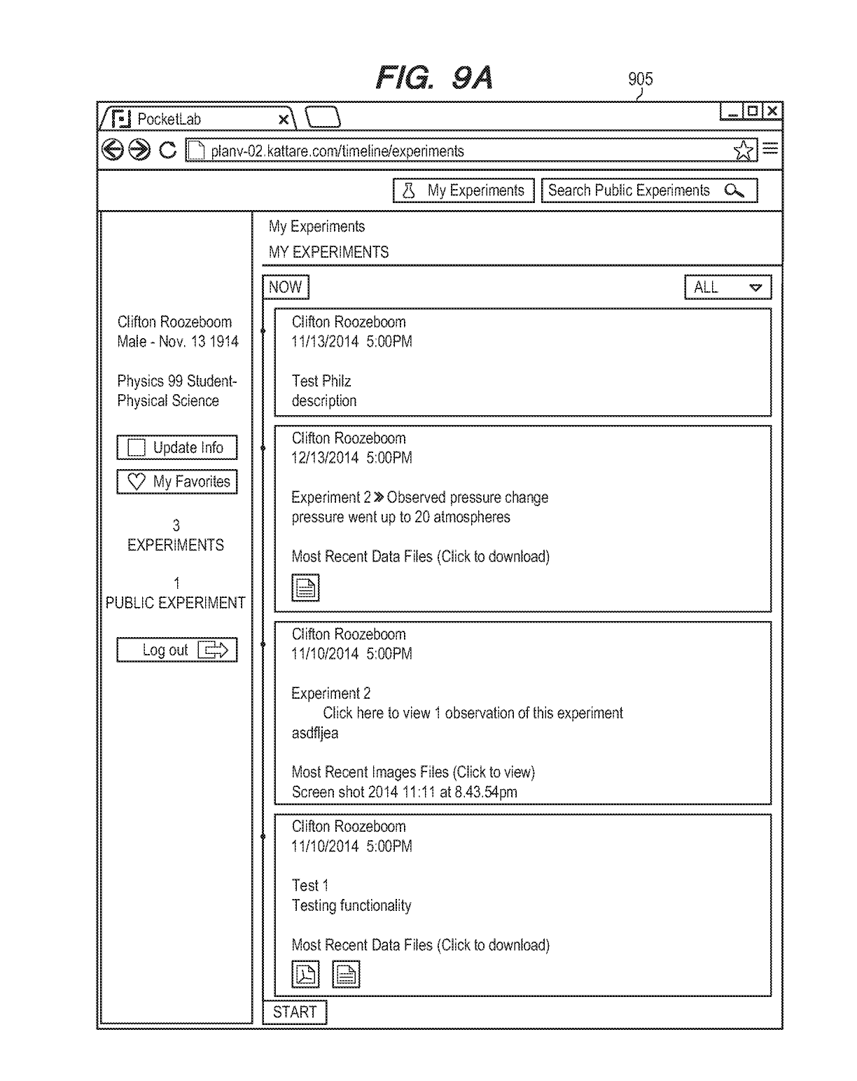

In an embodiment, an uploaded data series may be available for viewing and editing on a separate web interface 130. This allows the user to annotate each data series as an experiment and add notes for conditions related to that experiment. FIG. 9A illustrates an example of the web interface 130 where the user may track current and previous experiments and annotate current and previous experiments. View 905 illustrates a control screen where the user may view his past experiments and export the experiments as externally formatted data. For example, the user may export and download the data series in a comma separated format that can then be imported into programs such as Microsoft Excel or Google Drive. Other examples of data exporting include downloading a snapshot of the graph of the data series in PDF format.

View 905 illustrates other user options such as, searching publicly available experiments that exist on the cloud computing system 415. This option allows the user to collect and aggregate publicly available experiments into a single graphical representation for larger data analysis and display, as depicted by view 420.

In an embodiment, the web interface 130 may be configured to annotate current experiments or to add additional observations to an experiment. FIG. 9B illustrates an example screen for annotating an experiment. For the experiment labelled “Test 1” the user may click the “edit” button to edit the name of the experiment. The web interface 130 allows the user to also add an additional data series to the experiment by using the “add observation” button. In an embodiment, an experiment may also include adding publicly available data series from other users to the experiment.

5. Embodiments of Toy Objects

Embodiments of the toy are not limited to a ball with a cavity to embed the multi-sensor device 100. Other embodiments may include, but are not limited to: a toy secured to a stationary wall or ceiling by a rope, chain, or spring; a toy with a large inner cavity filled with air or gas; a toy car; and a toy that includes a wheel where the multi-sensor device 100 is attached to the wheel.

In an embodiment, the multi-sensor device 100 may be attached to an object that is attached to a wall or ceiling by a rope, string, or chain. In another embodiment the multi-sensor device 100 is attached directly using a rope, string, or chain to a wall or ceiling.

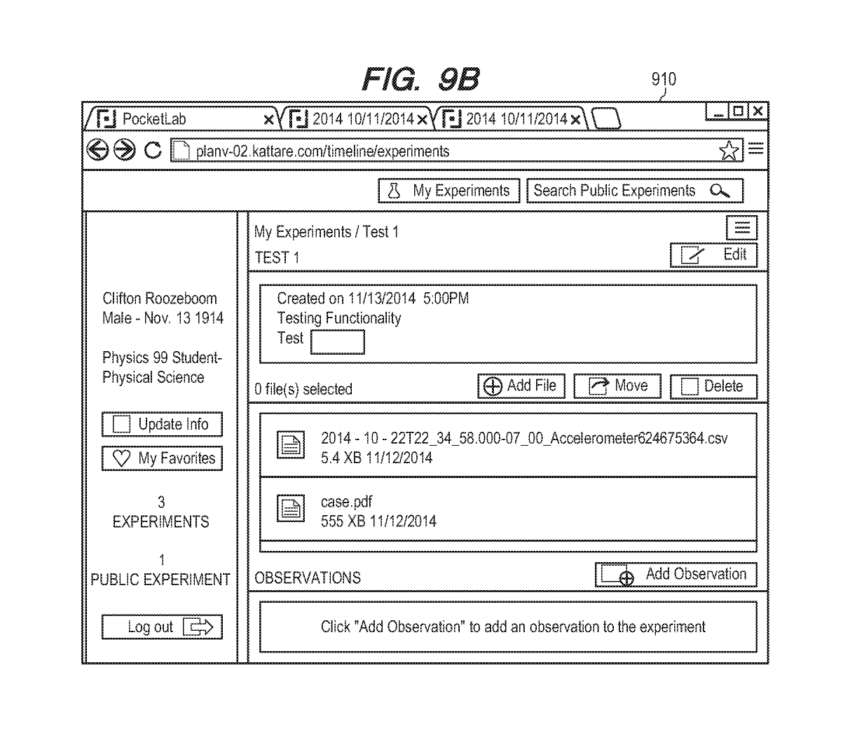

FIG. 10 illustrates an embodiment of a toy where the toy includes a ceiling, a rope, and the multi-sensor device attached to the rope. The purpose of this embodiment of the toy is to capture data series related to harmonic motion and the forces exerted on a pendulum. These forces may include, but are not limited to, g-forces, magnetic force, and acceleration that is related the swinging of a pendulum, where the multi-sensor device 100 is the weight of the pendulum and the pivot is where the rope is attached to the ceiling. FIG. 10 illustrates two views of the pendulum swinging where the forces detected by the multi-sensor device 100 are: the downward g-forces at the center point and at angle θ; 1 is the length of the rope that connects the multi-sensor device 100 to the ceiling; m is the weight of the multi-sensor device 100; and ax, ay are accelerations along the x-axis and y-axis.

In an embodiment, the toy may be a sealed bag that contains a gas within a large toy cavity. The toy cavity may be large enough to contain the gas and the multi-sensor device 100 for the purpose of detecting changes is atmospheric pressure. For example, when force is applied to the outside of the bag the pressure change within the cavity of the bag may be detected by a pressure sensor installed on the multi-sensor device 100.

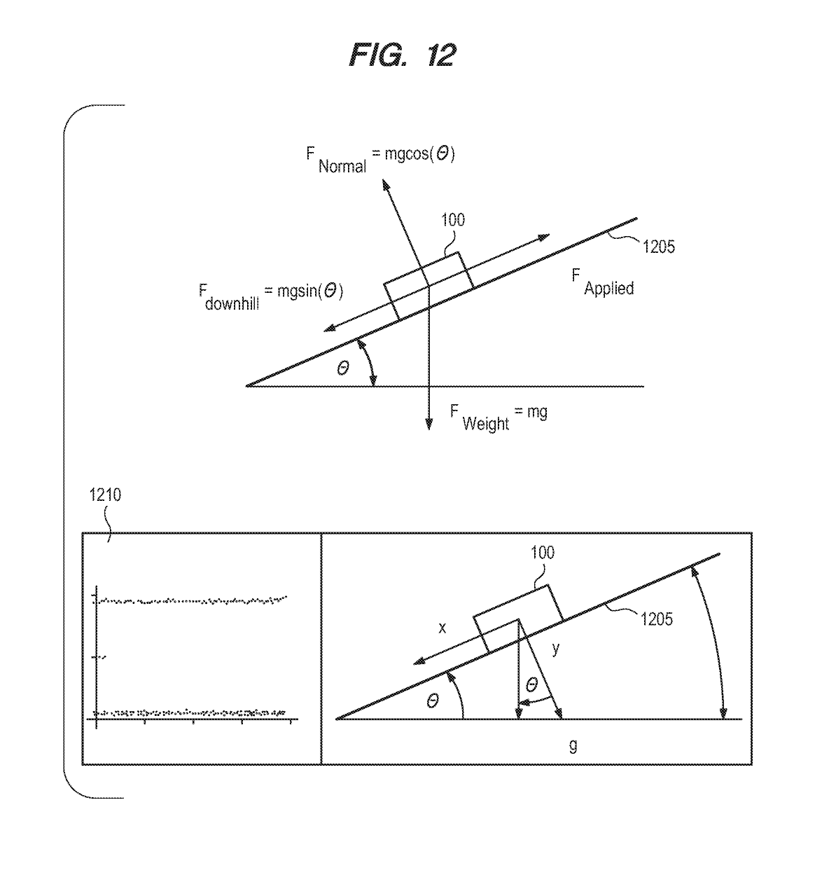

In an embodiment, the toy may be configured as a ramp where the multi-sensor device 100 rests on the top of a ramp that is angled. FIG. 12 illustrates an example ramp with the multi-sensor device resting on the ramp. Example equations, FNormal=mg cos(θ) and FDownhill=mg sin(0), describe forces exerted on the multi-sensor device 100 based upon the angle θ of the ramp. Graph output 1210 is used to visualize the magnitude of these forces on the mobile computing device 100, where the ramp is shown as line 1205.

In an embodiment, the toy may be implemented as a toy car where the mobile computing device 100 is located within the car such that the car's center of gravity is unaffected. By using a toy car, the mobile computing device 100 may be used to observe forces exerted by the car when rolling the car down a hill or when colliding a car into a wall.

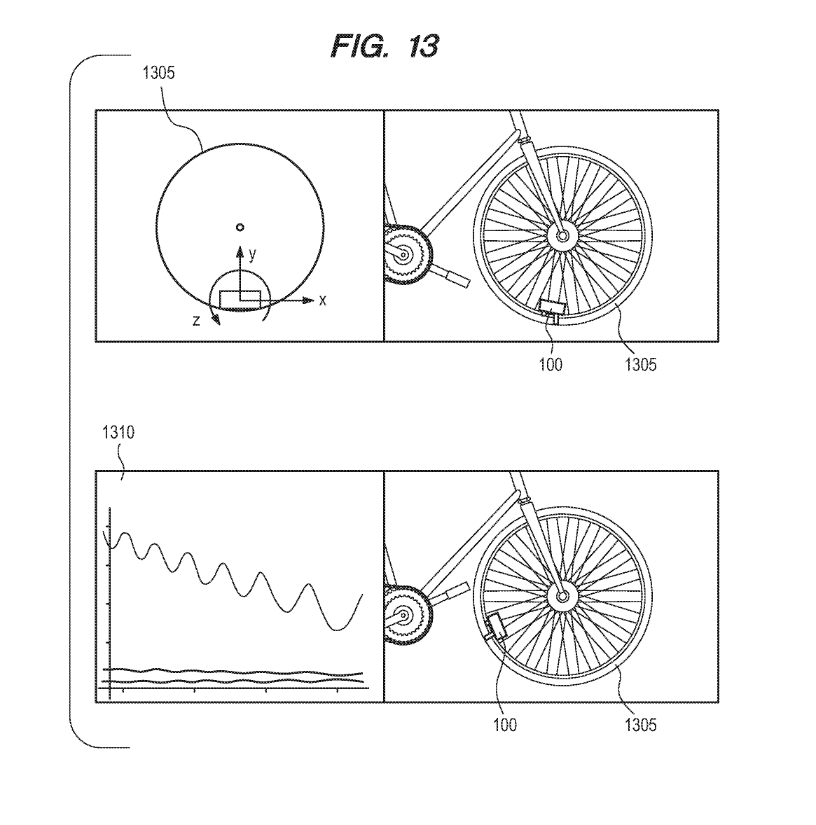

In an embodiment, the toy may be implemented as an object with a wheel such as a bicycle. The multi-sensor device 100 may attached to the wheel for the purpose of observing acceleration as the wheel rotates. FIG. 13 illustrates a bicycle with the multi-sensor device attached to the inside of the bicycle wheel. The multi-sensor device 100 is positioned so that rotation is measured along the x-axis and y-axis. Graph 1310 illustrates the rotation detected by a gyroscope within the multi-sensor device 100.

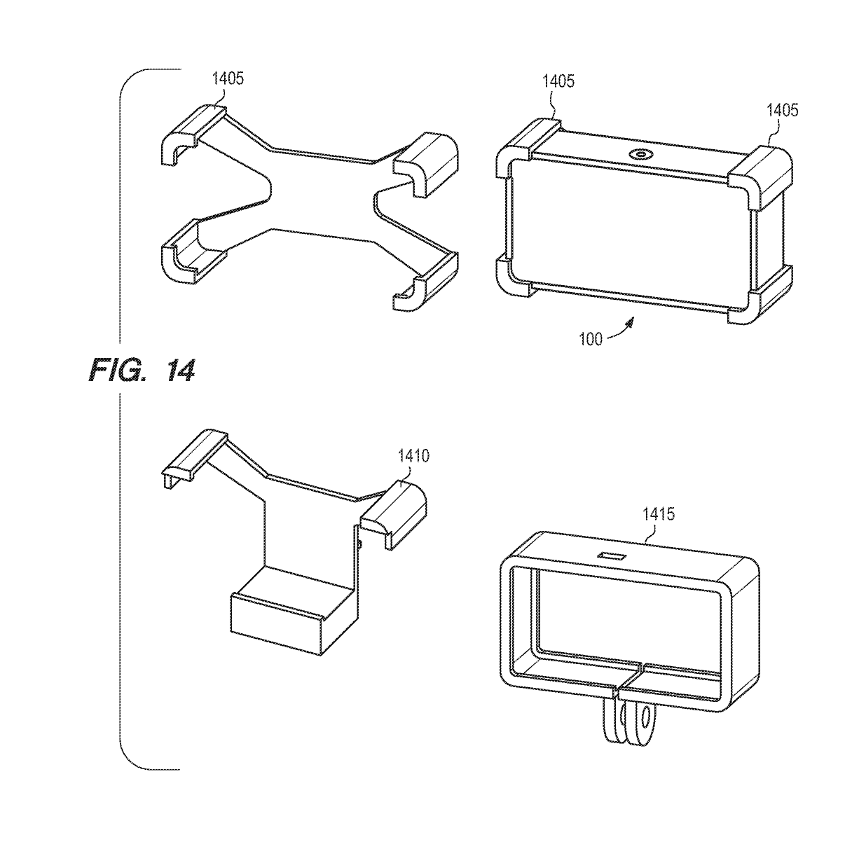

In an embodiment, the multi-sensor device 100 may be attached to a wheel or other toy using a mechanical mount. FIG. 14 illustrates multiple embodiments of a mechanical mount that holds the multi-sensor device. Mount 1405 is a multi-sensor device mount configured to hold the multi-sensor device 100 using attachable clips that attach to the outer corners of the multi-sensor device 100.

In an embodiment, mount 1410 may attach to the multi-sensor device 100 using a combination of two corner clips and a bottom clip that attaches to the bottom center of the multi-sensor device 100. The mount 1410 may also include exterior mounting screws that enable mount 1410 to attach to multiple toy objects.

In an embodiment, mount 1415 is designed to protect the multi-sensor device 100 be encasing the sides with a perimeter bracket. Mount 1415 is also equipped with an exterior mount designed to attach to multiple toy objects such as, a tripod, chassis, or screw mountable apparatus. Mount 1415 also illustrates an opening on the top of the perimeter bracket which may be used to allow sensors or buttons located on the side of the multi-sensor device to interact with the external environment. For example, the opening may allow a lens for an IR sensor, a pressure sensor, user control buttons that may be used to turn the multi-sensor device 100 on and off, or access area for electrical probes that may be externally connected to the multi-sensor device 100.

Other embodiments of a mount may include specialty mounting equipment that enables attachment to an armature of a robot, attachment to the outer surface of a ball, various hooks for a lanyard, or mounts that are threaded and can accept a screw or bolt. In an embodiment, the case can be surrounded by another outside protective case, or harder material, or water proof material, or soft material to cushion impact, or any other kind of outer shell.

6. Extensions and Alternatives

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

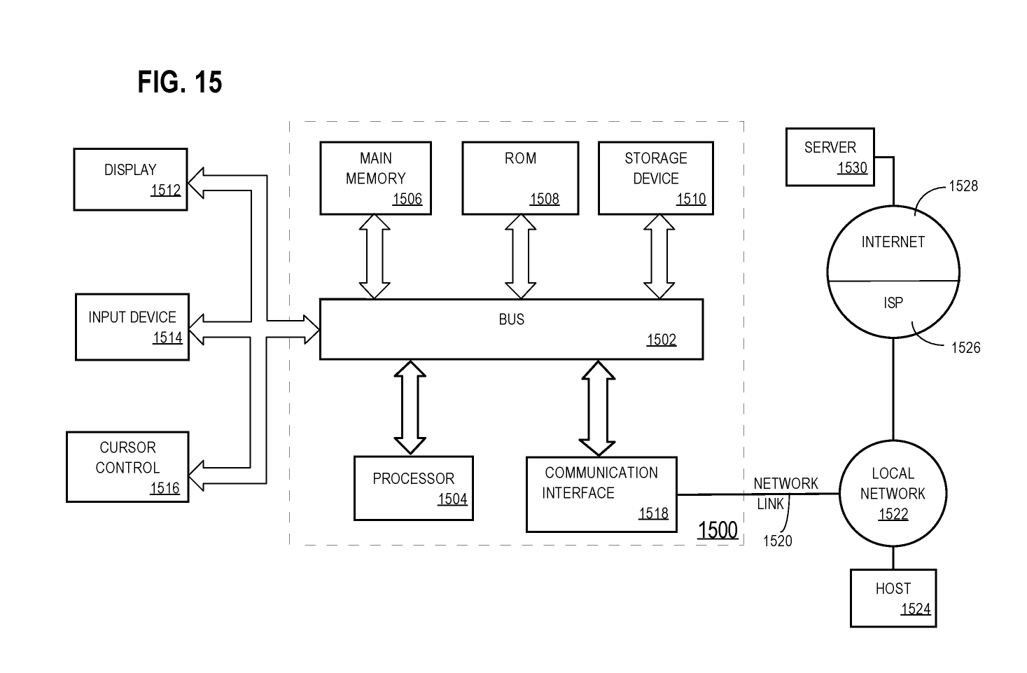

For example, FIG. 15 is a block diagram that illustrates a computer system 1500 upon which an embodiment of the invention may be implemented. Computer system 1500 includes a bus 1502 or other communication mechanism for communicating information, and a hardware processor 1504 coupled with bus 1502 for processing information. Hardware processor 1504 may be, for example, a general purpose microprocessor.

Computer system 1500 also includes a main memory 1506, such as a random access memory (RAM) or other dynamic storage device, coupled to bus 1502 for storing information and instructions to be executed by processor 1504. Main memory 1506 also may be used for storing temporary variables or other intermediate information during execution of instructions to be executed by processor 1504. Such instructions, when stored in non-transitory storage media accessible to processor 1504, render computer system 1500 into a special-purpose machine that is customized to perform the operations specified in the instructions.

Computer system 1500 further includes a read only memory (ROM) 1508 or other static storage device coupled to bus 1502 for storing static information and instructions for processor 1504. A storage device 1510, such as a magnetic disk, optical disk, or solid-state drive is provided and coupled to bus 1502 for storing information and instructions.

Computer system 1500 may be coupled via bus 1502 to a display 1512, such as a cathode ray tube (CRT), for displaying information to a computer user. An input device 1514, including alphanumeric and other keys, is coupled to bus 1502 for communicating information and command selections to processor 1504. Another type of user input device is cursor control 1516, such as a mouse, a trackball, or cursor direction keys for communicating direction information and command selections to processor 1504 and for controlling cursor movement on display 1512. This input device typically has two degrees of freedom in two axes, a first axis (e.g., x) and a second axis (e.g., y), that allows the device to specify positions in a plane.

Computer system 1500 may implement the techniques described herein using customized hard-wired logic, one or more ASICs or FPGAs, firmware and/or program logic which in combination with the computer system causes or programs computer system 1500 to be a special-purpose machine. According to one embodiment, the techniques herein are performed by computer system 1500 in response to processor 1504 executing one or more sequences of one or more instructions contained in main memory 1506. Such instructions may be read into main memory 1506 from another storage medium, such as storage device 1510. Execution of the sequences of instructions contained in main memory 1506 causes processor 1504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1510. Volatile media includes dynamic memory, such as main memory 1506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1502. Transmission media can also take the form of acoustic or light waves, such as those generated during radio-wave and infra-red data communications.

Various forms of media may be involved in carrying one or more sequences of one or more instructions to processor 1504 for execution. For example, the instructions may initially be carried on a magnetic disk or solid-state drive of a remote computer. The remote computer can load the instructions into its dynamic memory and send the instructions over a telephone line using a modem. A modem local to computer system 1500 can receive the data on the telephone line and use an infra-red transmitter to convert the data to an infra-red signal. An infra-red detector can receive the data carried in the infra-red signal and appropriate circuitry can place the data on bus 1502. Bus 1502 carries the data to main memory 1506, from which processor 1504 retrieves and executes the instructions. The instructions received by main memory 1506 may optionally be stored on storage device 1510 either before or after execution by processor 1504.

Computer system 1500 also includes a communication interface 1518 coupled to bus 1502. Communication interface 1518 provides a two-way data communication coupling to a network link 1520 that is connected to a local network 1522. For example, communication interface 1518 may be an integrated services digital network (ISDN) card, cable modem, satellite modem, or a modem to provide a data communication connection to a corresponding type of telephone line. As another example, communication interface 1518 may be a local area network (LAN) card to provide a data communication connection to a compatible LAN. Wireless links may also be implemented. In any such implementation, communication interface 1518 sends and receives electrical, electromagnetic or optical signals that carry digital data streams representing various types of information.

Network link 1520 typically provides data communication through one or more networks to other data devices. For example, network link 1520 may provide a connection through local network 1522 to a host computer 1524 or to data equipment operated by an Internet Service Provider (ISP) 1526. ISP 1526 in turn provides data communication services through the world wide packet data communication network now commonly referred to as the “Internet” 1528. Local network 1522 and Internet 1528 both use electrical, electromagnetic or optical signals that carry digital data streams. The signals through the various networks and the signals on network link 1520 and through communication interface 1518, which carry the digital data to and from computer system 1500, are example forms of transmission media.

Computer system 1500 can send messages and receive data, including program code, through the network(s), network link 1520 and communication interface 1518. In the Internet example, a server 1530 might transmit a requested code for an application program through Internet 1528, ISP 1526, local network 1522 and communication interface 1518.

The received code may be executed by processor 1504 as it is received, and/or stored in storage device 1510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A transportable toy system comprising:
a toy body;
a cavity in the toy body;
in the cavity, a sensor package comprising one or more processors; a plurality of electronic digital sensors coupled to the one or more processors and including two or more of an accelerometer, an altimeter, and a gyroscope; a wireless networking transceiver coupled to the one or more processors; a non-transitory computer-readable storage medium coupled to the one or more processors and storing one or more sequences of instructions which when executed by the one or more processors cause the one or more processors to perform:
in response to a change in position of the toy, detecting a set of changes to the toy, wherein the set of changes includes at least one of a change in position along an x-axis, a change in position along a y-axis, a change in position along a z-axis, a change in velocity along multiple axes, a change in acceleration along multiple axes, as the changes are detected, generating one or more signals that represent measurements of at least one of, acceleration, velocity, position, or rotation of the toy;
as the changes are detected, transmitting the one or more signals via the wireless networking transceiver to a mobile computing device that is separate from the toy;
wherein the sensor package is removable from the cavity and if removed utility of the toy is maintained; and
a host computer that is separate from the toy and from the mobile computing device and comprising a second non-transitory computer-readable storage medium storing second downloadable application instructions which when downloaded to and executed by the mobile computing device cause the mobile computing device to perform:
receiving the one or more signals;
compiling one or more data series comprising a plurality of values representing a plurality of measurements from the one or more signals;
wherein the one or more data series represent at least one of acceleration, velocity, position, or rotation of the toy in one or more directions,
presenting the one or more data series on a multi-axis graph.

2. The transportable toy system of claim 1, wherein the toy is a ball.

3. The transportable toy system of claim 1, wherein transmitting the one or more signals via the wireless networking transceiver uses Bluetooth technology standard.

4. The transportable toy system of claim 1, wherein the sensor package further comprises an external control button that when depressed toggles, on or off: detection of the set of changes to the toy, generation of one or more signals, and transmission of the one or more signals.

5. The transportable toy system of claim 1, wherein the non-transitory computer-readable storage medium instructions further include instructions which when executed by the one or more processors cause the one or more processors to perform:
in response to determining that a particular period of time has passed without detecting a change in position of the toy, invoking a sleep event which instructs the one or more processors to enter a sleep mode for a particular period of time;
in response to detecting a change in position of the toy when the one or more processors are in the sleep mode, waking up the one or more processors to detect the change in position of the toy.

6. The transportable toy system of claim 1, wherein the non-transitory computer-readable storage medium instructions of generating one or more signals further include storing the one or more signals within a storage medium with the sensor package.

7. The transportable toy system of claim 1, wherein the second non-transitory computer-readable storage medium storing second downloadable application instructions further includes instructions which when downloaded to and executed by the mobile computing device cause the mobile computing device to perform:
converting the one or more data series to one or more datasets configured to be compatible with an external application;
exporting the one or more datasets to the external application.

8. The transportable toy system of claim 1, wherein the second non-transitory computer-readable storage medium storing second downloadable application instructions further includes instructions which when downloaded to and executed by the mobile computing device cause the mobile computing device to perform:
annotating the one or more data series with a geo-tag that represents the geo-location of where the one or more signals that make up the one or more data series were generated;
uploading the one or more data series to an external storage server.

9. The transportable toy system of claim 8, wherein the second non-transitory computer-readable storage medium storing second downloadable application instructions further includes instructions which when downloaded to and executed by the mobile computing device cause the mobile computing device to perform:
retrieving one or more external data series from the external storage server, wherein the one or more data series have been uploaded from one or more mobile computing devices;
aggregating the one or more external data series into a single aggregated data series, which represents multiple data series from the one or more mobile computing devices;
presenting the single aggregated data series on a multi-axis graph.

10. The transportable toy system of claim 9, wherein the second non-transitory computer-readable storage medium storing instructions of retrieving one or more external data series from the external storage server comprises:
querying the external storage server for one or more external data series based upon the annotated geo-tag associated with each external data series;
retrieving the one or more external data series from the external storage server.

11. The transportable toy system of claim 8, wherein uploading the one or more data series to an external storage server comprises aggregating the one or more data series into an experiment, which represents data collected from the one or more data series during a specified period of time.

12. The transportable toy system of claim 1, wherein the second non-transitory computer-readable storage medium storing second downloadable application instructions further includes instructions which when downloaded to and executed by the mobile computing device cause the mobile computing device to perform:
sending a new set of instructions to the sensor package, which may reprogram detection, generation, and transmission parameters within the sensor package.
